(19) United States
(12) Patent Application Publication
(10) Pub. No.: US 2018/0127250 A1
(43) Pub. Date: May 10, 2018

(54) HOOKED PRY BAR DEVICE FOR SEPARATING METAL PARTS

(71) Applicant: Stepan Bizyaev, Brooklyn, NY (US)

(72) Inventor: Stepan Bizyaev, Brooklyn, NY (US)

(21) Appl. No.: 15/348,474

(22) Filed: Nov. 10, 2016

(51) Int. Cl. B66F 15/00

(52) U.S. Cl. CPC B66F 15/00

(57) ABSTRACT

A hooked pry bar device for separating metal parts for separating metal parts a torque rod with a proximate end and a distal end. A slide stop is coupled to the proximate end. A transition curve that has a second end is coupled at a first end to the distal end of the torque rod. A spacer plate that has a distal terminus is coupled at a proximate terminus to the second end of the transition curve. A penetrating plate that has a second endpoint is coupled at a first endpoint to the distal terminus of the spacer plate. The second endpoint can be inserted between two overlapping pieces of metal and is capable of cutting through attachments securing the pieces of metal together. The penetrating plate is placed between the overlapping pieces of metal. The user can apply force to the torque rod to separate the pieces of metal.

### BACKGROUND OF THE DISCLOSURE

### Field of the Disclosure

The disclosure relates to pry bar devices and more particularly pertains to a new hooked pry bar device for separating metal parts.

### SUMMARY OF THE DISCLOSURE

An embodiment of the disclosure meets the needs presented above by generally a torque rod with a proximate end and a distal end. A slide stop is coupled to the proximate end. A transition curve that has a second end is coupled at a first end to the distal end of the torque rod. A spacer plate that has a distal terminus is coupled at a proximate terminus to the second end of the transition curve. A penetrating plate that has a second endpoint is coupled at a first endpoint to the distal terminus of the spacer plate. The second endpoint can be inserted between two overlapping pieces of metal and is capable of cutting through attachments securing the pieces of metal together. The penetrating plate is placed between the overlapping pieces of metal. The user can apply force to the torque rod to separate the pieces of metal.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective top view of a hooked pry bar device for separating metal parts according to an embodiment of the disclosure.

FIG. 2 is a front view of an embodiment of the disclosure.

FIG. 3 is a top view of an embodiment of the disclosure.

FIG. 4 is a bottom view of an embodiment of the disclosure.

### DESCRIPTION OF THE PREFERRED EMBODIMENT

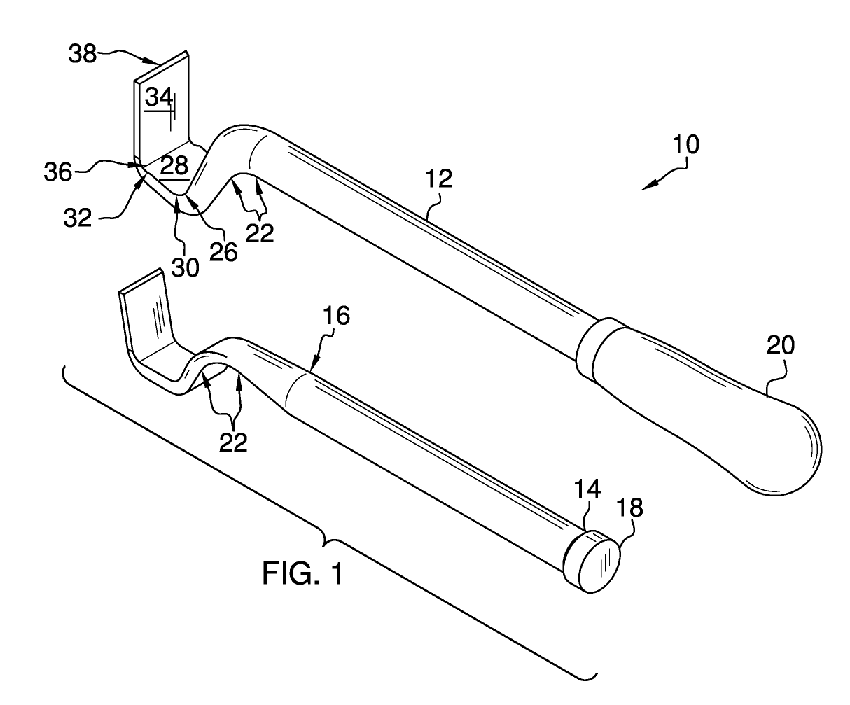

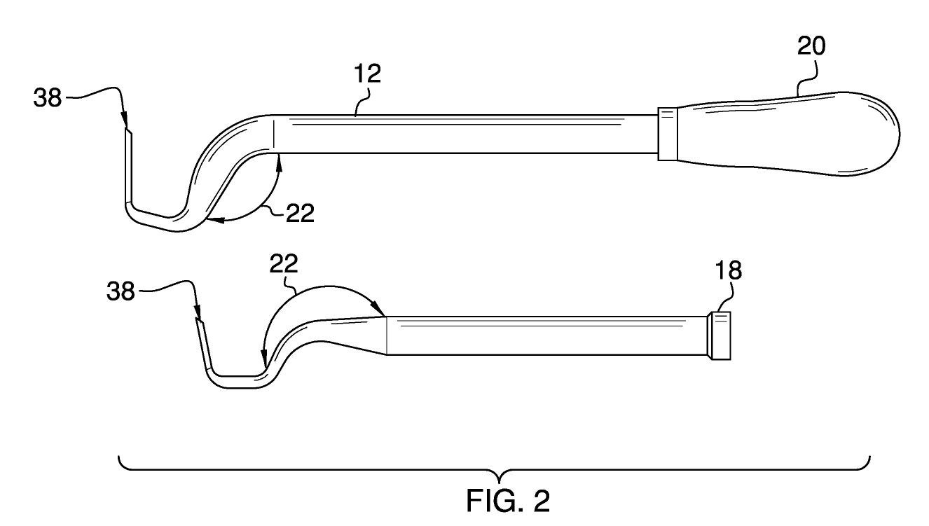

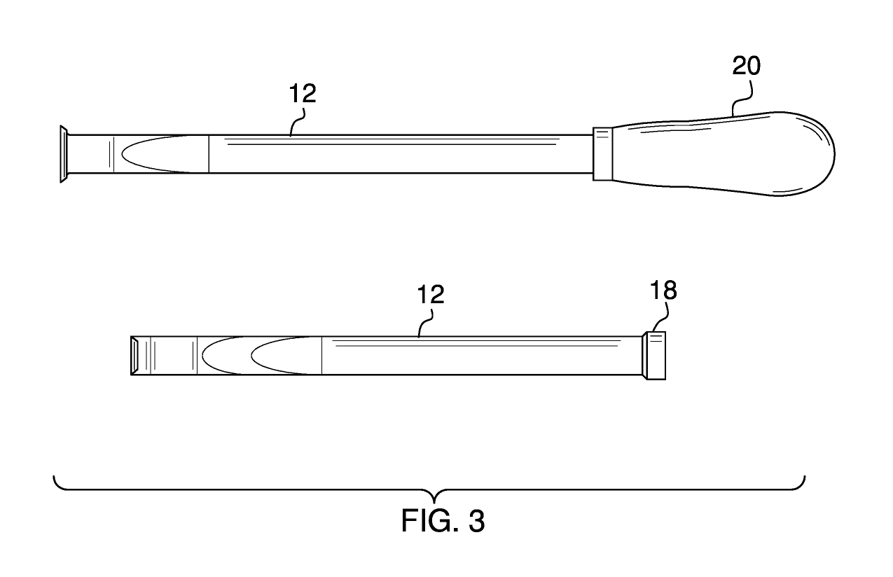

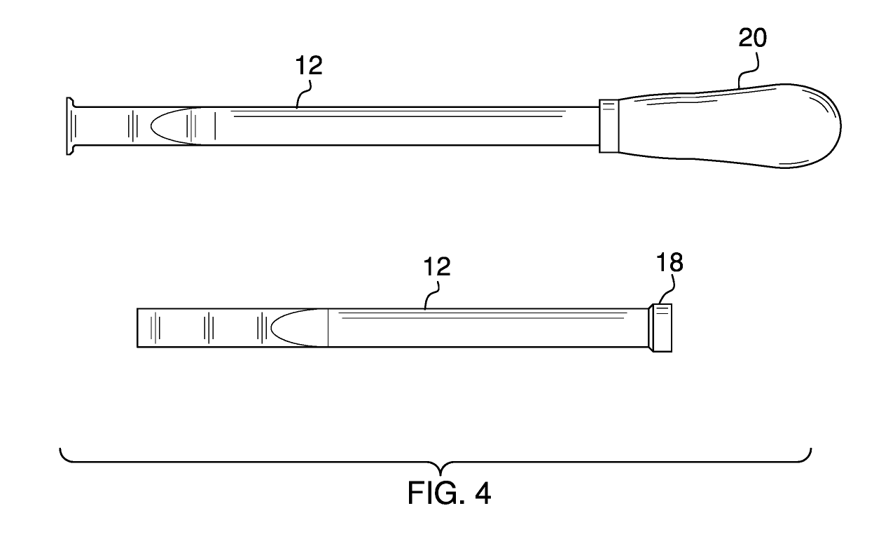

With reference now to the drawings, and in particular to FIGS. 1 through 4 thereof, a new pry bar device embodying the principles and concepts of an embodiment of the disclosure and generally designated by the reference numeral 10 will be described.

As best illustrated in FIGS. 1 through 4, the hooked pry bar device for separating metal parts 10 generally comprises a torque rod 12 with a proximate end 14 and a distal end 16. In one embodiment, the torque rod 12 is circularly shaped when viewed longitudinally. A slide stop 18 is coupled to the proximate end 14. In one embodiment, the slide stop 18 comprises a hollow handle 20 that is configured to overlay and couple to the proximate end 14 of the torque rod 12. A transition curve 22 that has a first end 24 and a second end 26 is coupled at the first end 24 to the distal end 16 of the torque rod 12. In one embodiment, the first end 24 of the transition curve 22 is circularly shaped when viewed longitudinally. The second end 26 is flat, such that the second end 26 is offset from the torque rod 12. A spacer plate 28 that has a proximate terminus 30 and a distal terminus 32 is coupled at the proximate terminus 30 to the second end 26 of the transition curve 22.

A penetrating plate 34 that has a first endpoint 36, opposing side edges 40 and a second endpoint 38 is coupled at the first endpoint 36 to the distal terminus 32 of the spacer plate 28. In one embodiment, the first endpoint 36 is beveled. In another embodiment, the first endpoint is doubly beveled to define a first cutting edge 42. In yet another embodiment, the first cutting edge is defined by double beveling of the first endpoint by 35 degrees.

In one embodiment, each opposing side edge 40 is beveled. In another embodiment, each opposing side edge 40 is doubly beveled to define a pair of second cutting edges 44. In yet another embodiment, each second cutting edge 44 is defined by double beveling of a respective opposing side edge 40 by 35 degrees.

In one embodiment, the torque rod 12, the transition curve 22, the spacer plate 28 and the penetrating plate 34 are comprised of steel. In another embodiment, the torque rod 12, the transition curve 22, the spacer plate 28 and the penetrating plate 34 are comprised of hardened steel. In yet another embodiment, the torque rod 12, the transition curve 22, the spacer plate 28 and the penetrating plate 34 are formed from a single piece of hardened steel.

In use, the second endpoint 38 can be inserted between two overlapping pieces of metal. The second endpoint 38 is capable of cutting through attachments securing the pieces of metal together and allowing the penetrating plate 34 to be placed between the overlapping pieces of metal. The user can apply force to the torque rod 12 using the handle 20, and a separating force will be transferred to the penetrating plate 34, causing the upper sheet of metal to separate from the lower sheet of metal.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hooked pry bar device for separating metal parts, said device comprising:
a torque rod, said torque rod having a proximate end and a distal end;
a slide stop, said slide stop being coupled to said proximate end;
a transition curve, said transition curve having a first end and a second end, said first end being coupled to said distal end of said torque rod;
a spacer plate having a proximate terminus and a distal terminus, said proximate terminus being coupled to said second end of said transition curve; and
a penetrating plate, said penetrating plate having a first endpoint, a second endpoint and opposing side edges, said first endpoint being coupled to said distal terminus of said spacer plate.

2. The device of claim 1, further comprising:
said torque rod being circularly shaped when viewed longitudinally;
said first end of said transition curve being circularly shaped when viewed longitudinally; and
said second end of said transition curve being flat.

3. The device of claim 1, further including said slide stop comprising a hollow handle configured to overlay and couple to said proximate end of said torque rod.

4. The device of claim 1, further including said torque rod, said transition curve, said spacer plate and said penetrating plate being comprised of steel.

5. The device of claim 4, further including said torque rod, said transition curve, said spacer plate and said penetrating plate being comprised of hardened steel.

6. The device of claim 5, further including said torque rod, said transition curve, said spacer plate and said penetrating plate being formed from a single piece of hardened steel.

7. The device of claim 1, further including said first endpoint being beveled.

8. The device of claim 7, further including said first endpoint being doubly beveled defining a first cutting edge.

9. The device of claim 8, further including said first cutting edge being defined by double beveling of said first endpoint by 35 degrees.

10. The device of claim 1, further including each said opposing side edge being beveled.

11. The device of claim 10, further including each said opposing side edge being doubly beveled defining a pair of second cutting edges.

12. The device of claim 11, further including each said second cutting edge being defined by double beveling of a respective said opposing side edge by 35 degrees.

13. A hooked pry bar device for separating metal parts, said device comprising:
a torque rod, said torque rod having a proximate end and a distal end, said torque rod being circularly shaped when viewed longitudinally;
a slide stop, said slide stop being coupled to said proximate end, said slide stop comprising a hollow handle configured to overlay and couple to said proximate end of said torque rod;
a transition curve, said transition curve having a first end and a second end, said first end being coupled to said distal end of said torque rod, said first end being circularly shaped when viewed longitudinally, said second end being flat, wherein said second end is offset from said torque rod;
a spacer plate having a proximate terminus and a distal terminus, said proximate terminus being coupled to said second end of said transition curve;
a penetrating plate, said penetrating plate having an first endpoint and a second endpoint, said first endpoint being coupled to said distal terminus of said spacer plate, said first endpoint being beveled, said first endpoint being doubly beveled defining a first cutting edge, said first cutting edge being defined by double beveling of said first endpoint by 35 degrees, each said opposing side edge being beveled, each said opposing side edge being doubly beveled defining a pair of second cutting edges, each said second cutting edge being defined by double beveling of a respective said opposing side edge by 35 degrees;
said torque rod, said transition curve, said spacer plate and said penetrating plate being comprised of steel, said torque rod, said transition curve, said spacer plate and said penetrating plate being comprised of hardened steel, said torque rod, said transition curve, said spacer plate and said penetrating plate being formed from a single piece of hardened steel; and
wherein said second endpoint can be inserted between two overlapping pieces of metal, wherein said second endpoint is capable of cutting through attachments securing the pieces of metal together, allowing said penetrating plate to be placed between the overlapping pieces of metal, wherein the user can apply force to said torque rod using said handle, wherein a separating force is transferred to said penetrating plate, causing the upper sheet of metal to separate from the lower sheet of metal.
